(19) United States
(12) Patent Application Publication
(10) Pub. No.: US 2006/0155005 A1
(43) Pub. Date: Jul. 13, 2006

(54) White ink composition for ink-jet recording, and inkjet image forming method and ink-jet image forming apparatus employing the same

(76) Inventors: Ai Kondo, Tokyo (JP); Satoshi Masumi, Odawara-shi (JP)

Correspondence Address: CANTOR COLBURN, LLP, 55 GRIFFIN ROAD SOUTH, BLOOMFIELD, CT, 06002, US

(21) Appl. No.: 11/324,928

(22) Filed: Jan. 4, 2006

(30) Foreign Application Priority Data
Jan. 11, 2005 (JP) JP2005-003537

(51) Int. Cl. C03C 17/00; B05D 1/32

(52) U.S. Cl. 523/160; 524/497; 427/466

(57) ABSTRACT

A white ink composition for ink-jet recording including: a white pigment; a dispersing agent; a polymerizable compound; and a photo-polymerization initiator, wherein, when an ink-jet image is formed with the white ink composition and hardened by irradiation of an activation energy ray to have a thickness of 5 through 20 μm, the hardened ink-jet image has a whiteness with lightness index of L*>90 and a chroma indexes of −2<a*<+2 and −5<b*<+5 in CIELAB color space, and a 60° mirror surface glossiness of no less than 80.

### BACKGROUND OF THE INVENTION

1. Field of the Invention

The invention relates to a white ink composition for ink-jet recording, and relates in detail to a white ink composition for ink-jet recording which forms an image having suitable whiteness and visibility on a transparent or a low lightness recording material having no ink absorbing ability, and is excellent in the color reproducibility, image quality, drying ability, adhesiveness with the substrate and durability.

2. Description of Related Art

The ink-jet recording method is noticed as a technology capable of forming an image simply and with low cost, and of recording a high quality image corresponding to various fields of printing as a result of recent improvement in the image quality. However, usual ink composition for ink-let recording is commonly a low viscosity composition mainly composed of an aqueous or non-aqueous solvent, and a recording material having ink absorbing ability or an exclusive recording material is necessary for obtaining higher image quality.

As an ink composition which can be contacted and printed on a recording medium such as film or metal, an ink composition containing an ingredient which can be polymerized by UV irradiation, cf. Patent Document 1, for example, and a UV hardening ink composition containing a colorant, UV hardening agent and photo-polymerization initiator, cf. Patent Document 2, for example, have been proposed.

Usual ink for ink-jet printing is almost high transparency inks for printing on a white opaque recording material. Therefore, sufficient contrast and clear color cannot be obtained and formation of image with high visibility is difficult when an image is printed on a transparent substrate or a substrate having low lightness such as that employed for soft packaging.

As a countermeasure to the low visibility, a method is known in which a white ink having hiding power is used as foundation for obtaining high visibility. As such the white ink composition, a white ink composition composed of a white pigment, an organic solvent and an adhesive resin, cf. Patent Document 3, for example, and a photo-hardening ink-jet recording-ink composition composed of titanium oxide, a polymerizable compound, a photo-polymerization initiator and an aqueous solvent, cf. Patent Document 4, have been proposed.

The tone of such the white ink composition for ink-jet recording is depended on the tone of the white pigment and that of another ingredient.

In the case of the light packaging use, a color image is usually printed on a transparent substrate and then a white image printed onto at least a part of the color image and non-image area; this procedure is so-called as back printing. In such the case, the glossiness of the hardened surface of the printed image is not to be a subject because the image is observed through the transparent substrate.

Besides, it is tried to prepare a printed matter or a proof for printing by a surface printing method in which a white image is printed on a transparent substrate and then a color image is printed onto at least a part of the white image. In such the case, it is necessary not only to approximate the color of the image to that of the objective printed matter but also the tone and the glossiness of the white background should be made agree with designated conditions. Particularly, high glossiness of the image surface is required when a high glossy substrate is used for obtaining high quality feeling.

Patent Document 1: Tokkai Hei 3-216379

Patent Document 2: U.S. Pat. No. 5,623,001

Patent Document 3: Tokko Hei 2-45663

Patent Document 4: Tokkai 2000-336295

The invention has been attained on the above background. An object of the invention is to provide a white ink composition for ink-jet recording, hereinafter also referred to as simply a white ink composition, which can form an image having suitable whiteness and visibility on a transparent recording material having no ink absorbing ability or that having low lightness, and is excellent in the color reproducibility, image quality, drying ability, adhesiveness with the substrate and durability, and an image forming method and an ink-jet recording apparatus using the white ink composition.

### SUMMARY OF THE INVENTION

One aspect of a feature of the embodiment to attain the above object is a white ink composition for ink-jet recording comprising: a white pigment; a dispersing agent; a polymerizable compound; and a photo-polymerization initiator,

wherein, when an ink-jet image is formed with the white ink composition and hardened by irradiation of an activation energy ray to have a thickness of 5 through 20 μm, the hardened ink-jet image has a whiteness with lightness index of L*>90 and a chroma indexes of −2<a*<+2 and −5<b*<+5 in CIELAB color space, and a 60° mirror surface glossiness of not less than 80.

### BRIEF DESCRIPTION OF THE DRAWINGS

FIG. 1 shows a front view of an example of constitution of principal part of an ink-jet recording apparatus of the invention.

FIG. 2 shows another example of constitution of principal part of an ink-jet recording apparatus of the invention.

### DETAILED DESCRIPTION OF-THE PREFERRED EMBODIMENTS

The above-mentioned object of the present invention is achieved by the following embodiments.

(1) A white ink composition for ink-jet recording comprising: a white pigment; a dispersing agent; a polymerizable compound; and a photo-polymerization initiator,

wherein, when an ink-jet image is formed with the white ink composition and hardened by irradiation of an activation energy ray to have a thickness of 5 through 20 μm, the hardened ink-jet image has a whiteness with lightness index of L*>90 and a chroma indexes of −2<a*<+2 and −5<b*<+5 in CIELAB color space, and a 60° mirror surface glossiness of not less than 80.

(2) The white ink composition for ink-jet recording of (1), wherein the white pigment is a titanium oxide.

(3) The white ink composition for ink-jet recording of (1) or (2), wherein the dispersing agent has an acid value and an amine value.

(4) The white ink composition for ink-jet recording of (3), wherein the acid value is greater than the amine value.

(5) The white ink composition for ink-jet recording of any one of (1) to (4), further comprising a silicone surfactant having HLB value of 9 through 30.

(6) The white ink composition for ink-jet recording of any one of (1) to (5), further comprising an oxetane compound as a dispersion medium.

(7) The white ink composition for ink-jet recording of any one of (1) to (6), further comprising a colorant other than the white pigment.

(8) The ink-jet image forming method, comprising:

ejecting the white ink composition of any one of (1) to (7) 1 onto a recording medium; and

irradiating an activation energy ray on the white ink composition ejected on the recording medium to form a hardened image.

(9) The ink-jet image forming method of (8), wherein, the step of irradiating an activation energy ray is performed at a time between 0.001 to 2.0 seconds after a landing of the white ink composition on the recording medium.

(10) The ink-jet image forming apparatus comprising:

a recording head to eject the white ink composition described any one of (1) to (7) onto a recording medium; and

a irradiation section to irradiate an activation energy ray on the white ink composition ejected on the recording medium to harden the white ink composition,

wherein, the recording head ejects the white ink composition after the white ink composition and the recording head have been heated to 35 through 100° C.

The invention is described in detail below.

White Ink Composition

The white ink composition to be employed in the invention comprises a white pigment, a polymerizable compound and a photo-polymerization initiator.

Whiteness:

It is found by the inventors that the visibly excellent whiteness, high sharpness and improved color reproducibility of the hardened layer of the white ink composition can be obtained when each of the lightness index L* and the perceived color index a* and b* according to L*a*b* system (CIELAB) recommended by Commission International de l “Echairage” are within a specific range.

Namely, the white ink composition is provided which displays a lightness index of the surface L* and perceived color index a* and b* measured according to JIS-Z8722 and expressed according to JIS-Z8730 are respectively not less than 90, from −2 to +2, and from −5 to +5, when a layer having a thickness of from 5 to 20 μm made by forming of the white ink composition and being hardened by irradiation of activation energy ray.

In the invention, for example, the whiteness is measured by forming a white solid image having a thickness of 12 μm on a transparent substrate having a transmission density of not more than 0.05 and putting it on a sheet of coated paper such as Tokubishi Art Paper manufactured by Mitsubishi Paper Mills Limited.

Glossiness

The glossiness of the image surface formed by hardening ink-jet ink is depended on the inherent characteristics of the ink and the status of the dots relating on the timing of irradiation of energy until hardening. For example, a matted surface with large surface irregularity is formed when the layer is hardened before the spreading of the ink on the recording medium, and a glossy surface is formed by leveling the ink when the hardening is slowly performed.

The glossiness is mainly controlled by the irradiation timing for forming low glossiness, and is mainly controlled by the composition and the characteristics of the ink for forming high glossiness.

High glossiness is required for obtaining high quality feeling or high visibility, and the high glossy surface is largely depending on the materials and characteristics of the ink, particularly on the hardening property of the polymerizable compound and the permissibility of them when two or more kinds of the compounds are employed in the hardening composition.

It is found that a high glossy layer can be obtained by the ink-jet image formation when the mirror surface glossiness of the hardened layer at 60° is not less than 80; the layer is formed by coating the white ink composition is on the recording medium and hardened by irradiation of the activation energy ray.

Such the high glossy hardened layer can be successfully obtained when a cation polymerization type photo-polymerizable resin is employed.

For obtaining the high glossy hardened layer, the use of the dispersing agent is effectual. The dispersing agent having an acid value and an amine value is preferable and that in which the acid value is larger than the amine values and the different between them is preferably from 1 mg/g KOH to 30 mg/g. The effect cannot be obtained when the difference is less than 1 mg/g KOH, and there is possibility of hardening of the layer by thermal reaction when the difference is more than 30 mg/g. The high molecular weight dispersing agent is preferable, though one having the low molecular weight may be employable. Concrete examples of preferable dispersion agent include Ajisper PB824 and PB822, manufactured by Ajinomoto Fine Techno Co., Ltd., and Hinoact KF-1300M, KF-1700 and T-6000, manufactured by Kawaken Fine Chemicals Co., Ltd., but the dispersing agent is not limited to the above.

The acid value and the amine value in the invention are the values each determined by the potentiometric titration. The values can be measured by the method described in “Journal of the Japan Society of Color Material (Shikizai Kyokai Shi)”, 61, [21], p.p. 692 to 698, 1988. In the invention, the measurement is carried out according to the following method.

(Determination of Amine Value of Dispersing Agent)

The dispersing agent is dissolved in methyl i-butyl ketone (MIBK) and subjected to potentiometric titration by using a 0.01 mol/L perchloric acid MIBK solution; the result is converted into KOH mg/g to determine the amine value. The potentiometric titration is carried out by an automatic titration apparatus COM-1500, manufactured by Hiranuma Sangyo Co., Ltd.

(Determination of Acid Value of Dispersing Agent)

The dispersing agent is dissolved in methyl i-butyl ketone (MIBK) and subjected to potentiometric titration by using a 0.01 mol/L potassium methoxide MIBK solution; the result is converted into KOH mg/g to determine the acid value. The potentiometric titration is carried out by the foregoing automatic titration apparatus COM-1500.

The silicone surfactant to be employed in the invention has a HLB value of from 9 to 30, more preferably from 12 to 20. The dot diameter control relating to the invention cannot be performed when the HLB is less than 9, and the hardening ability is influenced when the value is more than 30.

The viscosity at 25° C. of the silicone surfactant is preferably from 200 mPa·s to 10 mPa·s from the viewpoint of the ejection property. It is preferable that decreasing in the surface tension of the hardenable composition is within the range of from 0 to 5 mN/m when 1% by weight of the silicone surfactant relating to the invention is added to the reactive photo-hardenable composition or ink of the composition. By satisfying such the condition, the stability of ejecting and the strength of the hardened layer can be consisted. The adding amount of the silicone surfactant is preferably from 0.001 to 10% by weight.

Concrete examples of the silicone surfactant having a HLB value of from 9 to 30 include KF-351, KF-618, X-22-4966 and KF-6011, manufactured by Shin-Etsu Chemical Co., Ltd, FZ-2163 and L77, manufactured by Nihon Unicar Co., Ltd., and BL2, manufactured by Nihon Chemicals Co., Ltd.

The HLB value is determined according to the following equation by measuring of a clouding number A.
HLB=0.89×(Clouding number A)+1.11

The clouding number can be measured by a method in which a solution of 0.5 g of the silicone surfactant dissolved in 5 ml of methanol is titrated by 2% phenol solution while keeping the temperature at 25° C. The end point is defined by occurrence of turbid in the solution, and the volume in ml of the 2% phenol solution necessary for occurring the turbid is defined as the clouding number A.

The mirror surface glossiness at 60° is measured by the method according to JIS-Z-8741 with respect to the hardened layer having uniform surface status and thickness formed on the recording medium. The hardened layer having the uniform surface status and thickness can be formed by various methods such as a dipping coating method, a roller coating method, a fountain coating method, air-knife coating method, a blade coating method, a bar coating method and a slide hopper coating method. In concrete, for example, the white ink composition is coated on the recording medium so that the hardened layer thickness becomes 12 μm and irradiated by UV lamp to form the hardened layer.

White Pigment

The white pigment to be employed in the invention may be any one capable of making white the ink composition, and white pigments usually applied in the field of the art can be employed. Inorganic white pigments, organic white pigments and white hollow fine particle of polymer can be employed for such the white pigment.

Examples of the inorganic white pigment include a sulfate of alkali-earth metal such as barium sulfate, a carbonate of alkali-earth metal such as calcium carbonate, silica such as fine powdered silicic acid and synthesized silicate, calcium silicate, alumina, hydrated alumina, titanium oxide, zinc oxide, talk and clay.

Examples of the organic white pigment include organic compound salt disclosed in Tokkai Hei 11-129613, and alkylenebismelamine derivatives described in Tokkai 2001-234093.

As the white hollow fine particle of polymer, the thermoplastic fine particle substantially composed of an organic polymer described in U.S. Pat. No. 4,089,800 is employable. Among the above white pigments, titanium oxide is preferable from the viewpoint of the hiding power, coloring ability and dispersing ability.

Though titanium oxide takes three crystal states, anatase type, rutile type and brookite type, the crystal states are commonly classified into anatase type and rutile type. The anatase type crystal is small in the specific gravity and is easily made to fine particles, and the rutile type crystal is high in the refractive index and the hiding power. Though the both types can be employed in the invention, it is preferable to suitably select according to the use for making the best of their characteristics. The dispersion stability, storage ability and jet-out suitability of the ink can be improved by the use of the anatase type crystal which has low specific gravity and easily can be made to fine particle. Tow or more kinds of the crystal may be employed, and the adding amount of titanium oxide can be reduced by the combination use of the anatase type and rutile type having high coloring ability so that the storage ability and the jet-out suitability of the ink can be improved.

For surface treatment of the titanium oxide, an aqueous treatment or a gas phase treatment is applied, and an alumina-silica treating agent is usually employed. Untreated-, alumina treated- or alumina-silica treated-titanium oxide are employable.

The average particle diameter of the titanium oxide is preferably from 50 to 500 nm. Sufficient hiding power cannot be obtained when the average diameter is less than 50 nm, and the storage ability and the jet-out suitability of the ink tend to be degraded when the average diameter exceeds 500 nm.

The white pigments may be employed singly or in combination.

Polymerizable compound and Photo-polymerization initiator

Photo-hardning type materials using the photo-polymerizable composition such as those described in Tokkai Hei 7-159983, Tokkou Hei 7-31399, Tokkai Hei 08-224982 and Tokkai Hei 10-863, and cation polymerizing type photo-hardening resins are known as radical polymerizable compounds and cation photo-polymerizing type photo-e resin optically sensitized in long wavelength region not shorter than visible light are recently disclosed in Tokkai Hei 6-43633 and 08-324137, for example.

The radical polymerizable compound is a compound having a radical polymerizable ethylenic unsaturated bond, and any compounds having at least one radical polymerizable ethylenic unsaturated bond in the molecule thereof are employable, and the compound includes ones in the chemical states of monomer, oligomer and polymer. The radical polymerizable compounds may be employed singly or in combination of two or more kinds thereof in an optional ratio for improving the characteristics. A poly-functional compound having two or more functional groups is preferable than a mono-functional compound. The use of two or more kinds of the poly-functional compounds is preferable for controlling the properties such as reactivity and physical characteristics.

Examples of the compound having the radical polymerizable ethylenic unsaturated bond include unsaturated carboxylic acid such as acrylic acid, methacrylic acid, itaconic acid, crotonic acid, isocrotonic acid, maleic acid and salts, esters, urethanes, amides and anhydrides thereof, acrylonitrile, styrene, various kinds of unsaturated polyesters, unsaturated polyethers, unsaturated polyamides, and unsaturated urethanes. In concrete, the followings can be cited; acrylic acid derivatives such as 2-ethylehexyl acrylate, 2-hydroxylethyl acrylate, butoxyethyl acrylate, carbitol acrylate, cyclohexyl acrylate, tetrahydrofurfuryl acrylate, benzyl acrylate, bis(4 acryloxypolyethoxyphenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythrytol triacrylate, pentaerythrytol tetracrylate, dipentaerythrytol tetracrylate, trimethylolpropane triacrylate, tetramethylolmethane tetracrylate, acrylic oligoester, N-methylolacrylamide, diacetoneacrylamide and epoxy acrylate, and methacryl derivatives such as methyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, 1,6-hexanediol dimethacrylate, ethylene glycol dimethacrylate, triethylene glycol dimethacrylate, polyethylene glycol dimethacrylate, polyoropylene glycol dimethacrylate, trimethylolmethane trimethacrylate, trimethylolpropane trimethacrylate and 2,2-bis(4-methacryloepoxypolyethoxyphenyl)propane, and allyl compound derivatives such as allyl glycidyl ether, diallyl phthalate and triallyl trimeritate. Furthermore, ones on the market and radical polymerizable or crosslinkable monomers, oligomers and polymers known in the field of the art can be employed, which are described in “Crosslinking Agent Hand Book”, edited by S. Yamashita, 1981, Taisei-sha, “UV-EB Hand Book (Materials)”, edited by K. Kato, 1985, Koubunshi Kankou-kai, “UV•EB Hardening Technology, Application and Market”, edited by Radtech Kenkyu Kai, 1989, CMC, E. Takiyama “Polyester Resin Hand Book”, 1988, Nikkan Kogyo Shinbyn-sha. The adding amount of the radical polymerizable compound is preferably from 1 to 97% by weight and more preferably from 30 to 95% by weight.

Examples of the radical polymerization initiator include triazine derivatives described in Tokkou Sho 59-1281 and 61-9621, and Tokkai Sho 60-60104; organic peroxide compounds described in Tokkai Sho 59-1504 and 61-243807; diazonium compounds described in Tokkou Sho 43-23684, 44-6413 and 47-1604, and U.S. Pat. No. 3,567,453; organic azide compounds described in U.S. Pat. Nos. 2,848,328, 2,852,379 and 2,940,853; orthoquinone diazide compounds described in Tokkou Sho 36-22062, 37-13109, 38-18015 and 45-9610; various onium compounds described in Tokkou Sho 55-39162 and 59-14023, and “Macromolecules”, vol. 10, p. 1307, 1977; azo compounds described in Tokkai Sho 142205; metal allene complexes described in Tokkai Hei 1-54440, EP Nos. 109,851 and 126,712, and “Journal of Imaging Science”, vol. 30, p. 174, 1986; (oxo)sulfonium organic boron complexes described in Tokkai Hei 5-213861 and 5-255347; titanosen compounds described in Tokkai Sho 61-151197; transition metal complexes containing a transition metal such as ruthenium described in “Coordination Chemistry Review”, vol. 84, p.p. 85 to 277, 1988, and Tokkai Hei 2-182701; 2,4,5-triarylimidazole dimaers described in Tokkai Hei 3-209477; carbon terachloride; and organic halogen compounds described in Tokkai Sho 59-107344. These radical polymerization initiators are preferably contained from 0.01 to 10 parts by weight to 100 parts by weight of the compound having the radical polymerizable ethylenic unsaturated bond.

For the cation polymerizing type photo-hardening resin, an epoxy type hardening type prepolymer or monomer having two or more epoxy groups in one molecular thereof is employable. Examples of such the prepolymer include alicyclic polyepoxides, polyglycidyl esters of polybasic acid, polyglycidyl ethers of polyol, polyglycidyl ethers of polyoxyalkylene glycol, polyglycidyl ethers of aromatic polyol, hydrogenated compound of polyglycidyl ethers of aromatic polyol, urethane epoxy compounds and epoxided polybutadienes. These prepolymers may be employed singly or in combination of two or more kinds thereof.

An aromatic onium salt is employable as the initiator for the cation polymerizing photo-hardening resin. Examples of the aromatic onium salt include salts of elements of Group Va of the periodical table, for example, phosphonium salts such as triphenylphenacylsulfonium hexafluorophosphate, sulfonium salts of elements of Group VIa, for example, sulfoniym salts such as triphenylsulfonium tetrafluoborate, triphenylsulfonium hexafluorophosphate, tris(4-thiomethoxyphenyl)sulfonium hexafluorophosphate and triphenylsulfonium hexafluoroantimonate, and salts of elements of Group VIIa, for example, iodonium salts such as diphenyliodonium chloride.

The use of such the aromatic onium compounds for the cation polymerization initiator for polymerization of the epoxy compounds is described in detail in U.S. Pat. Nos. 4,058,401, 4,069,055, 4,101,513 and 4,161,478.

As the preferable cation polymerization initiator, the sulfonium salts of elements of Group VIa are cited. Among them, a triarylphosphonium heaxfluoroantimonate is preferable from the viewpoint of the UV hardening ability and the storage stability of the UV hardening composition. Moreover, photo-polymerization initiators described on pages 39 to 56 of “Photopolymer Hand Book”, edited by Photopolymer Konwa-kai, 1989, Kogyo Chosakai, and compounds described in Tokkai Sho 64-13142 and Tokkai Hei 2-4804 are optionally employable.

In the invention, cation type photo-polymerizable compounds and photo acid generation agents are preferably employed described in Tokkai 2004-315778.

Tone Controlling Agent

A toner controlling agent is employed together with the white pigment for obtaining whiteness suitable for the purpose. Usually used colorant and fluorescent whitening agent are usable for the tone controlling agent.

A dye type colorant and a pigment type colorant can be used as the tone controlling agent, and the pigment type colorant is particularly preferable from the viewpoint of the storing stability of the tone of the finally formed image. Examples of the colorant and the whitening agent to be added include dye type colorants, for example, azo compounds such as ditizone and formazane, quinine type compounds such as naphthoquinone, anthraquinone, acrydone, anthanthrone, indantrene, pyrenedione and bioranthrone, quinine imines such as azine, oxazine and thiazine, indigo dyes such as indilbine, oxyindigo and thioindigo, sulfur dyes, diphenylmethane, triphenylmethane compounds such as fluorane, fluoresceine and Rhodamine, ferosene, fluorenone, fulgide, perylene, phenazine, phenothiazine, polyene compounds such as calotene, maleic acid derivative, pyrazone, stilbene and styryl, polymethine compounds such as cyanine, pyridinium, pyrylium, quinolinium and Rhodamine, xanthene, alizarine, acrydine, acrydinone, carbostyryl, coumaline, diphenylamine, quinacridone, quinophthalone, phenoxadine, phthaloperynone, porphine, chlorophyll, phthalocyanine, crown compounds, squalilium, thiafluvalene, thiazole, nitro dyes, nitroso dyes and colorants formed from leuco dyes; pigment type colorants such as titanium black, titanium yellow, ultramarine blue, prussian blue, cobalt blue, carbon black, iron black, zinc oxide, cobalt oxide, silicone oxide, aluminum hydroxide, azo pigments, phthalocyanine pigments, dye lakes, starch, synthesized resin particle such as urea-formalin resin and melamine resin, and silicone particle, and fluorescent whitening agents such as derivatives of stilbene type, distilbene type, coumaline type, oxazole type, benzoxazole type, imidazolone type, benzimidazole type and pyrazoline type compounds.

The tone controlling agent may be employed singly or in combination of two or more kinds thereof.

Though the adding amount of the tone controlling agent is not limited as long as the required color can be obtained, the agent is usually used in an amount of from 0.001 to 1% by weight.

(Oxetane Compound)

Oxetane compounds are preferably employed as the dispersion medium in the invention, and the oxetane compounds to be used in the invention are usable together with known oxetane compounds. Among them, oxetane compounds each having a substituent only at 3-position preferably can be used with together. Known oxetane compound having a substituent only at the 3-position such as those described in Tokkai 2001-220526 and 2001-310937 may be employed.

As the compounds having a substituent only at the 3-position, ones represented by the following Formula 27 are exemplified.

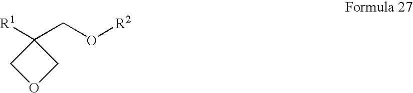

In Formula 27, R¹ is a hydrogen atom, an alkyl group having 1 to 6 carbon atoms such as a methyl group, an ethyl group, a propyl group and a butyl group, a fluoroalkyl group having 1 to 6 carbon atoms, an allyl group, an aryl group, a furyl group or a thienyl group. R² is an alkyl group such as a methyl group, an ethyl group, a propyl group and a group, an alkenyl group having 2 to 6 carbon atoms such as a 1-propenyl group, a 2-propenyl group, a 2-methyl-1-propenyl group, a 2-methyl-2-propenyl group, a 1-butenyl group, 2-butenyl group and a 3-butenyl group, a group having an aromatic ring such as a phenyl group, a benzyl group, a fluorobenzyl group, a methoxybenzyl group and a phenoxyethyl group, an alkoxycarbonyl group having 2 to 6 carbon atoms such as an ethylcarbonyl group, a propylcarbonyl group and butylcarbonyl group, an alkoxycarbonyl group having 2 to 6 carbon atoms such as an ethoxycarbonyl group, a propoxycarbonyl group and a butoxycarbonyl group, or a N-alkylcarbamoyl group having 2 to 6 carbon atoms such as an ethylcarbamoyl group, a propylcarbamoyl group, a butylcarbamoyl group and a pentylcarbamoyl group. An oxetane compound having one oxetane ring is particularly preferable because which is superior in the adhesiveness and in the working facility because of low viscosity thereof.

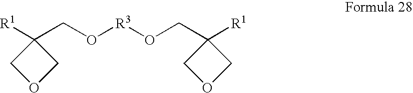

In Formula 28, R¹ is the same groups represented by R¹ in Formula 27, R³ is a linear or branched chain alkylene group such as an ethylene group, a propylene group and a butylene group, a polyalkylene (alkyleneoxy) group such as a poly(ethyleneoxy) group and a poly(propleneoxy) group, a unsaturated linear or branched chain hydrocarbon group such as a propenylene group, a methylpropenylene group and a butenylene group, a carbonyl group, an alkylene group containing a carbonyl group, or an alkylene group containing a carbamoyl group.

R³ may be a polyvalent group selected from the groups represented by Formula 29, 30 or 31.

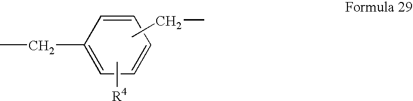

In Formula 29, R⁴ is an alkyl group having 1 to 4 carbon atoms such as a methyl group, an ethyl group, a propyl group and a butyl group, an alkoxy group having 1 to 4 carbon atoms such as a methoxy group, an ethoxy group, a propoxy group and a butoxy group, a halogen atom such as a chlorine atom and a bromine atom, a nitro group a cyano group, a lower alkoxycarbonyl group, a carboxyl group or a carbamoyl group.

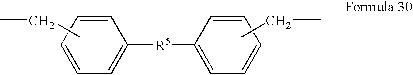

In Formula 30, R⁵ is an oxygen atom, a sulfur atom, a methylene group, NH, SO, SO₂, C(CF₃)₂ or C(CH₃)₂.

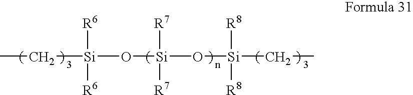

In Formula 31, R⁶ is an alkyl group having 1 to 4 carbon atoms such as a methyl group, and ethyl group, a propyl group and a butyl group, or an aryl group. n is an integer of from 0 to 2,000. R⁷ is an alkyl group having 1 to 4 carbon atoms such as a methyl group, an ethyl group, a propyl group and a butyl group, or an aryl group. Moreover, R⁷ may be a group selected from the group represented by the following Formula 32.

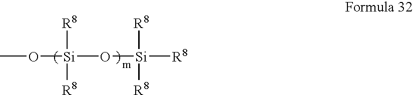

In Formula 32, R⁸ is an alkyl group having 1 to 4 carbon atoms such as a methyl group, an ethyl group, a propyl group and a butyl group, or an aryl group. m is an integer of from 0 to 100.

Concrete examples of the compound having two oxetane rings include the following compounds.

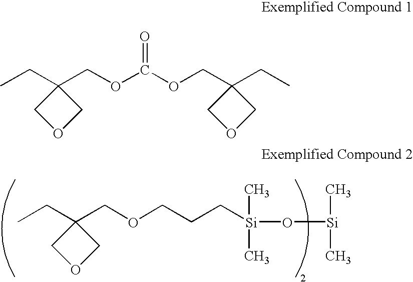

Exemplified Compound 1 is a compound of Formula 28 in which R¹ is an ethyl group and R³ is a carboxyl group. Exemplified Compound 2 is a compound of Formula 28 in which R¹ is an ethyl group, R³ is a group represented by the foregoing Formula 31, R⁶ and R⁷ are each a methyl group and n is 1.

Preferable examples of the compound having two oxetane rings other than the above compounds include compounds represented by Formula 33. In Formula 33, R¹ is synonymous with R¹ in Formula 27.

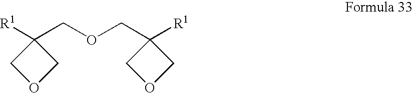

Examples of the oxetane compound having three or four oxetane rings include those represented by the folslowing Formula 34.

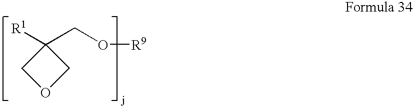

In formula 34, R¹ is synonymous with R¹ in Formula 27. R⁹ is a branched alkylene group having 1 to 12 carbon atoms such as that represented by the following A to C, a branched polyalkyleneoxy group such as that represented by D, or a branched polysiloxy group such as that represented by E. j is an integer of 3 or 4.

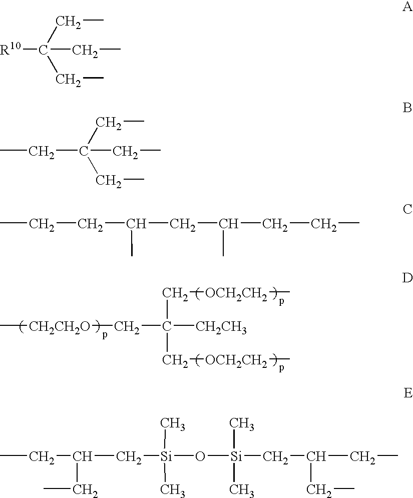

In the above A, R¹⁰ is a lower alkyl group such as a methyl group, ethyl group and a propyl group. In the above D, p is an integer of from 1 to 10.

An example of the compound having 3 or 4 oxetane rings is Exemplified Compound 3.

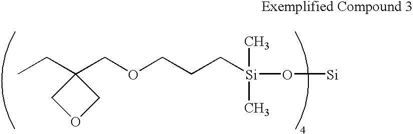

Examples of the compound having 1 to 4 oxetane rings include those represented by the following Formula 35.

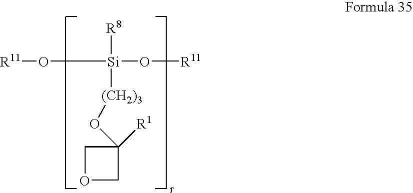

In Formula 35, R⁸ is a synonymous with R⁸ in Formula 32. R¹¹ is an alkyl group having 1 to 4 carbon atoms such as a methyl group, an ethyl group, a propyl group and a butyl group, or a trialkylsilyl group. r is an integer of from 1 to 4.

Preferable examples of the oxetane compound relating to the invention include the following Exemplified Compounds 4 through 6.

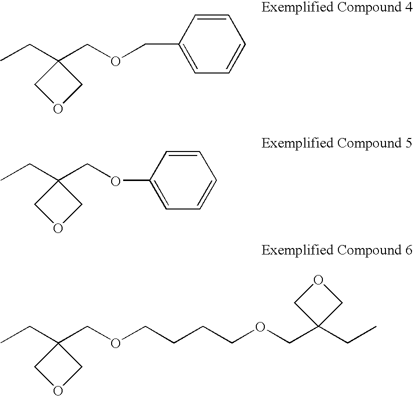

The production method of the above compounds having oxetane ring is not specifically limited and can be produced by a usually known method, for example, the method disclosed by D. P. Pattison, J. Am. Chem. Soc. 3455, 79, 1957, in which the oketane is synthesized from a diol compound. Other than the above-mentioned, compounds each having 1 to 4 oxetane rings and a high molecular weight of from 1,000 to 5,000 are employable. Concrete examples of such the compound are the following Exemplified Compounds 7, 8 and 9.

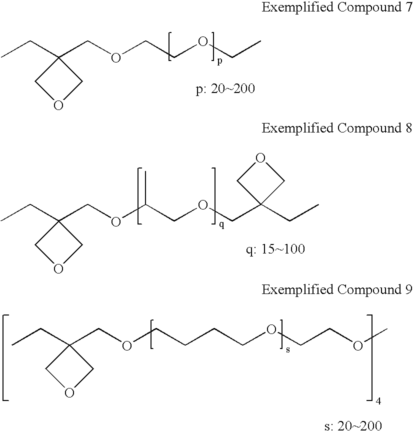

For dispersing the pigment, a ball mill, a sand mill, an attriter, a roll mill, an agitator, a henschel mixer, a colloid mill, an ultrasonic homogenizer, a pearl mill, a wet jet mill and a paint shaker can be applied. A dispersant may be added on the occasion of the dispersing.

The dispersant improves the dispersed state of the titanium oxide in the ink composition so as to improve the kneading suitability on the occasion of the preparation of the composition and the storage ability and the ejection property of the composition after the preparation. Examples of the dispersant include poly(ethylene glycol) ester compounds, poly(ethylene glycol) ether compounds, polyoxyethylene sorbitol ester compounds, sorbitol alkyl ester compounds, aliphatic polycarboxylic acid compounds, phosphoric ester compounds, amidoamine salts of polyester acid, Poly(ethylene oxide) compounds, aliphatic acid amide wax, amine salts of polyetherester acid, amidoamine salts of high molecular weight polyester acid, high molecular weight copolymers, high molecular weight block copolymers, salts of a unsaturated polyaminoamide and a low molecular weight acid polymer, hydroxyl group-containing carboxylic acid compounds having affinity with the dispersing element, copolymers of a polymer of a low molecular weight unsaturated acidic polycarboxylic acid and a polysiloxane, copolymers of a polymer of a low molecular weight unsaturated acidic polycarboxylic acid polyester and a polysiloxane, copolymers of a partial amide of low molecular weight unsaturated polycarboxylic acid polymer, an alkylammonium compound and a polysiloxane, alkylammonium polycarboxylate compounds, polyamidoamino polycarboxylate compounds and low molecular weight unsaturated acidic polycarboxylic acid polyester compounds.

Among the above dispersants, the dispersion stability, storage ability and the ejection property of the ink are further improved by the use of the high molecular weight copolymer or the high molecular weight polycarboxylic acid amidoamine salt among the above surfactants.

The adding amount of the surfactant is preferably from 1 to 30%, and more preferably from 3 to 15%, by weight of the titanium oxide.

The white pigment is contained in the ink composition in a ratio of from 1 to 50%, preferably from 2 to 30%, by weight of the entire ink. When the content is lower that the above, sufficient hiding power cannot be obtained and when the content is higher than that, the ejecting ability is degraded and blocking of the ink is caused.

Another Ingredient

Another ingredient can be added to the ink to be employed in the invention according to necessity. Though the initiator is unnecessary when electron rays or X-rays are applied for the irradiation, a radical polymerization initiator, an initiation assistant or a sensitizing dye corresponding to the wavelength of the irradiating ray is added when UV rays, visible rays or infrared rays are applied for the radiation source. The amount of such the additive of from 1 to 10 parts by weight of the entire ink is necessary. The initiator is selected from ones soluble in the polymerizable compound, though various known compounds can be employed for the initiator. In concrete, xanthone or thioxanthone type, benzophenone type, quinine type and phosphine oxide type initiators are employable.

A polymerization prohibiting agent can be added in an amount of from 200 to 20,000 ppm for raising the storage ability. The addition of the polymerization prohibiting agent is preferable for preventing the blocking of the jetting head by thermal polymerization since the ink is preferably jetted in a state of heated at 40 to 80° for lowering viscosity.

Other than that, a surfactant, a leveling agent, a matting agent, and a polyester type resin, a polyurethane type resin, a vinyl type resin, an acryl type resin, a rubber type resin and a wax for controlling the physical property of the layer can be added. A tackifier not hindering polymerization is preferably added for improving the contacting ability to the recording medium of olefin resin or PET. For improving the contacting ability, extremely small amount of an organic solvent not influencing to drying may also be added. In such the case, the addition in the amount within the range for not causing problem of solvent resistivity or VOC is effectual; the amount is from 0.1 to 5%, and more preferably from 0.1 to 3%.

A radical-cation hybrid type hardening ink can be prepared by combining a cation polymerizable monomer having a long life for initiator and an initiator for preventing lowering in the sensitivity caused by the light shielding effect of the ink colorant.

Viscosity of White Ink Composition

The constitution ratio is decided so that the viscosity of the white ink composition is from 20 to 500 Pa·s at 30° C., or from 20 to 500 mPa·s at 30° C. and becomes to from 7 to 30 Pa·s by heating by not less than 40° C.

By raising the viscosity at room temperature, permeation of the ink into an absorbable recording material is prevented, reducing of the unhardened monomer and the odor can be reduced and spreading of the dot on the occasion the landing of the ink can be inhibited so as to improve the image quality. Moreover, similar image quality can be obtained when the surface tension of the substrate is different since the similar dot is formed on the substrates different in the surface tension from each other. When the viscosity is less than 20 mPa·s, the spreading prevention effect is insufficient, and the viscosity of more than 500 mPa·s causes a problem on the supplying of the ink.

The viscosity of the white ink composition is preferably from 7 to 30 mPa·s for obtaining stable ejecting ability.

Ink Ejecting Condition

It is preferable for stably ejecting the ink to heat the recording head and the ink at a temperature of from 30 to 100° C. The viscosity of the ink composition is largely varied depending on the temperature, and the variation in the viscosity directly influences on the size and jet out speed of the droplets and causes degradation in the image quality. Therefore, it is necessary to raise and stably keep the temperature of the ink. The allowance of the temperature control is ±5° C., preferably ±2° C., and more preferably ±1° C. of the set temperature.

Light Irradiating Condition after Landing of Ink

In the image forming method of the invention, the activation light is preferably irradiated at a time between 0.001 to 5.0 seconds, and more preferably from 0.001 to 2.0 seconds, after the landing of the ink. The surface glossiness corresponding to the purpose can be obtained by controlling the timing of the irradiation. It is important to make shorter the timing when lower surface glossiness is required, and to make longer the timing when the higher glossiness is required.

The basic method for irradiating the activation light is disclosed in Tokkai Sho 60-132767. According to this method, light sources are arranged on both sides of the head unit and the light sources are driven for scanning by shuttle like motion. The irradiation is performed after certain time of the landing of the ink. And then, the hardening is completed by another light source without driving. A method using optical fiber and a method in which collimated light is reflected by a mirror provided a side of the head unit so as to irradiate UV rays to the recording portion, are disclosed in U.S. Pat. No. 6,145,979. Any of such the methods can be applied in the invention.

A method in which the irradiation is separated into two steps and irradiation of activation light is firstly performed at a time between 0.001 to 2.0 seconds after the landing of the ink and activation light irradiation is secondary carried out after completion of entire printing, is one of preferable embodiments. The shrinkage of the recording material on the occasion of the hardening of the ink can be inhibited by separating the irradiation of activation light into two steps.

Hitherto, a high intensity light source exceeding 1 kW·hr in the total consumption of electric power is usually used for inhibiting the spreading of the dot after the landing of the ink. Particularly in the case of printing on a shrinking label, however, shrinkage of the recording material is too large so as not to be accepted for practical use when such the light source is applied.

In the invention, high precise images can be formed even when a light source with a electric power consumption of not more than 1 kW per hour, and the shrinkage of the recording material can be inhibited within the range acceptable for the practical use. Examples of the light source with a power consumption of not more than 1 kW/hr include a fluorescent lamp, a cold cathode ray tube and a LED, but the light source is not limited to them.

The recording apparatus according to the invention is described below referring the drawings. The recording apparatus displayed in the drawings is only an embodiment of the recording apparatus of the invention, and the apparatus of the invention is not limited to that of the drawings.

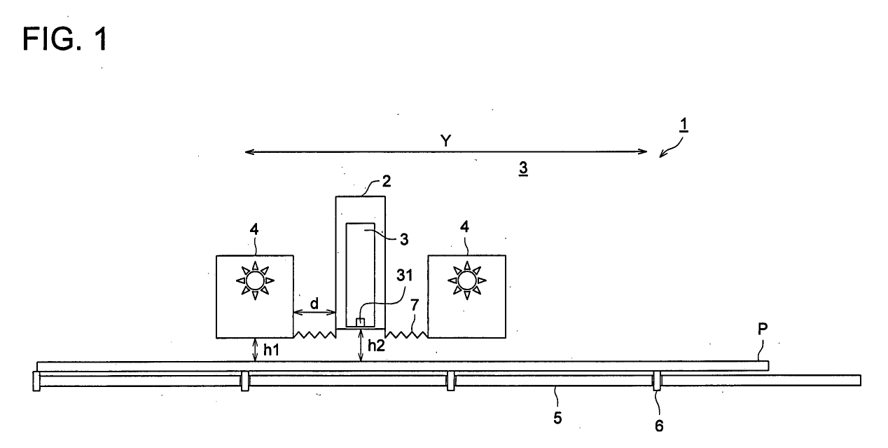

FIG. 1 is a front view showing the constitution of the principal part of the recording apparatus of the invention. The recording apparatus 1 has a head carriage 2, a recording head 3, an irradiating means 4 and a platen 5. In the apparatus 1, the platen 5 is arranged under a recording material P. The platen 5 functions as UV absorber and absorbs excessive UV rays passed through the recording material P so that the precision image can be reproduced with very high stability.

The recording material is moved from this side to the inside in FIG. 1 by action of a conveying means, not shown in the drawing, while being guided by a guiding member 6. The scanning is carried out by a head scanning means, not shown in the drawing, by which the recording head 3 held by the head carriage is reciprocally moved by the motion of the head carriage in the direction Y in FIG. 1.

Head carriage 2 is provided above the recording material P, head carriage containing recording head 3 such that the ejection hole is arranged downside. Head carriage 2 is provided on the recording apparatus main body in such a manner as reciprocally movable along Y direction in FIG. 1, and is moved by driving of the head scanning means.

Tough it is shown in FIG. 1 that the head carriage 2 contains the recording head 3, the recording head 3 in the head carriage 2 may optionally contain a color ink together with the white ink in practical use.

The recording head 3 jets out an activation light effectual type ink such as a UV hardening ink through a ejecting mouth onto the recording material P by the action of plural ejecting means, not shown in the drawing, the ink is supplied by a ink supplying means, not shown in the drawing. The UV hardening ink to be jetted out from the recording head 3 comprises the colorant, the polymerizable monomer and the initiator and is hardened by crosslinking and polymerizing reaction of the monomer in accordance with the catalytic effect of the initiator when the ink is irradiated by UV rays.

The recording head 3 jets out the UV hardening ink droplets so as to be landed onto a certain area (an area on which the ink can be landed) on the recording material P during the scanning performed by the motion of the recording head from one end to the other end of the recording material on the direction Y in FIG. 1 by the driving by the scanning means.

The above scanning is carried out for suitable times for finishing the ejecting of the UV hardening ink onto one area on which the ink can be landed, and then the recording material P is suitably moved from this side to the inside in FIG. 1. After that, the scanning by the recording head 3 is replayed for ejecting the UV hardening ink for landing the ink onto the next area adjacent to the inside area in FIG. 1.

An image constituted by assembling of the UV hardening ink droplets is formed by repeating the above procedure for ejecting the UV hardening ink from the recording head 3 gearing the head scanning means with the conveying means.

The irradiation means contains a UV lamp emitting UV ray within a specified wavelength range with stable exposure energy and a filter passing a specified wavelength of UV rays. For the UV lamp, a mercury lamp, a metal halide lamp, an excimer laser, a UV laser, a cool cathode tube, a hot cathode tube, a black light and a light emitting diode (LED) are employable, and the band-shaped metal halide lamp, cold cathode tube, hot cathode tube, mercury lamp and black light are preferred. The low pressure mercury lamp, cold cathode tube, hot cathode tube and a sterilizing lamp each emitting V rays of a wavelength of 254 nm are preferable, by which the prevention of spreading and the control of the dot diameter can be effectively carried out. The irradiating means for hardening the UV hardening ink can be prepared with lower cost by the use of the black light for the radiation source of the irradiating means 4.

The size of the irradiating means 4 is almost the same as or larger than the maximum size capable of being set in the recording apparatus or the UV ink-jet printer 1 within the area covered by once scanning by the recording head 3 driven by the scanning means.

The irradiating means 4 is fixedly installed on both sides of the head carriage almost in parallel with the recording material P.

The luminance at the ink ejecting portion can be controlled by an method in which the distance h2 between the ink ejecting portion 31 and the recording material is make larger than that h1 between the irradiation means 4 and the recording material P (h1>h2) or a method in which the distance d between the recording head 3 and the irradiating means 4 is make large are effectual, of course the recording head 3 can be wholly shielded from light. It is more preferable that a bellows structure 7 is put between the recording head and the irradiating means.

The wavelength of UV rays irradiated by the irradiating means 4 can be suitably varied by exchanging the UV lamp or the filter provided in the irradiating means 4.

The ink of the invention is excellent in the stability of the ejection property and is particularly effectual for image forming by the line head type recording apparatus.

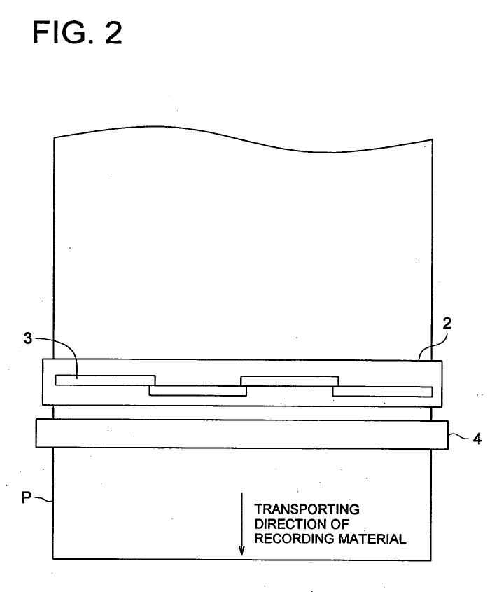

FIG. 2 is a top view of principal portion of another example of the ink-jet recording apparatus.

The ink-jet recording apparatus is called as a line head system, in which plural ink-jet recording heads of each color are fixedly provided in the head carriage 2 so as to cover the entire width of the recording material P.

Besides, the irradiating means 4 is provided on the downstream side of the head carriage 2 so as to wholly cover the width of the recording material P.

In the line head system, the head carriage and the irradiating means are fixed and the recording material is only conveyed and subjected to ink-jetting and hardening for forming the image.

### EXAMPLES

The invention is concretely described below, but the embodiment of the invention is not limited to the examples.

<Preparation of Titanium Oxide Dispersion>

The following compositions were mixed by a pressing kneader and kneaded and dispersed by a roller mill to obtain titanium oxide dispersions 1 through 3.

Titanium Oxide Dispersion 1

| | |
|---|---|
| Titanium oxide (average diameter of primary particles | 50.0% by weight |
| of 0.22 μm, aluminum treated) | |
| Polymer dispersant: Ajisper PB822 (Ajinomoto Fine- | 3.0% by weight |
| techno Co., Ltd.) | |
| Oxetane compound: Alon Oxetane OXT-221 | 47.0% by weight |
| (Toa Gousei Kagaku Co., Ltd.) | |

Titanium Oxide Dispersion 2

| | |
|---|---|
| Titanium oxide (average diameter of primary particles | 50.0% by weight |
| of 0.25 μm) | |
| High molecular weight polyester acid amidoamine salt | 4.0% by weight |
| type surfactant: DA-7300 (Kusumoto Chemicals, Ltd.) | |
| Oxetane compound: Alon Oxetane OXT-221 | 46.0% by weight |
| (Toa Gousei Kagaku Co., Ltd.) | |
| Blue colorant: TB-520 Blue 2B (Dainichi | 0.03% by weight |
| Seika Co., Ltd.) | |

Titanium Oxide Dispersion 3

| | |
|---|---|
| Titanium oxide (average diameter of primary | 50.0% by weight |
| particles of 0.16 μm) | |
| Polymer dispersant: Ajisper PB822 (Ajinomoto | 3.0% by weight |
| Fine-techno Co., Ltd.) | |
| Oxetane compound: Alon Oxetane OXT-221 | 47.0% by weight |
| (Toa Gousei Kagaku Co., Ltd.) | |
| Fluorescent whitening agent: Hakkol SAP-L) | 0.005% by weight |
| (Showa Kagaku Kogyo Co., Ltd.) | |

Herein,

PB822: Acid value is 18.5 mg KOH/g, and amine value is 15.9 mg KOH/g.

DA-7300: Acid value is 11.0 mg KOH/g, and amine value is 30.0 mg KOH/g.

Disperbyk-111: Acid value is 129.0 mg KOH/g, and amine value is none.

<White Ink Composition>

| | |
|---|---|
| Titanium oxide dispersion | 30.0% by weight |
| Alicyclic epoxy compound: Compound 1 | 17.8% by weight |
| Oxetane compound: Alon Oxetane OXT-221 | 34.2% by weight |
| (Toa Gousei Co., Ltd.) | |
| Oxetane compound: Alon Oxetane OXT-212 | 9.0% by weight |
| (Toa Gousei Co., Ltd.) | |
| Oxetane compound: Alan Oxetane OXT-101 | 3.0% by weight |
| (Toa Gousei Co., Ltd.) | |
| Photo-polymerization initiator: TAS-A | 5.0% by weight |
| Basic compound triisopropanolamine | 0.1% by weight |
| Surfactant: KF351 (Shin′ etsu Silicone Co., Ltd.) | 0.8% by weight |
| Perfume: Linaroul (Takasago International Corp.) | 0.1% by weight |

Compound 1

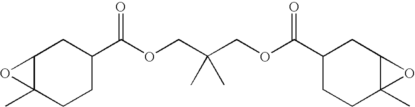

TAS-A

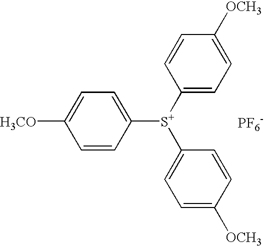

The white ink compositions 1 through 3 were prepared according to the above prescription by using the above titanium oxide dispersion 1 through 3.

Further, by using the above titanium oxide dispersion 1 through 3, according to the following prescription, the white ink compositions 4 through 6 were prepared.

| | |
|---|---|
| Titanium oxide dispersion | 30.0% by weight |
| Alicyclic epoxy compound: (Compound 1) | 17.8% by weight |
| Oxetane compound: Alon Oxetane OXT-221 | 35.0% by weight |
| (Toa Gousei Co., Ltd.) | |
| Oxetane compound: Alon Oxetane OXT-212 | 9.0% by weight |
| (Toa Gousei Co., Ltd.) | |
| Oxetane compound: Alon Oxetane OXT-101 | 3.0% by weight |
| (Toa Gousei Co., Ltd.) | |
| Photo-polymerization initiator: TAS-B | 5.0% by weight |
| Basic compound triisopropanolpropane | 0.1% by weight |
| Perfume: Linaroul (Takasago International Corp.) | 0.1% by weight |

TAS-B:

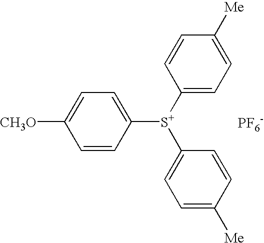

### Comparative Example

A mill base was prepared by the following method described in Example 1 in Tokkai 2004-59857, and an ink for ink-jet recording was prepared by using the mill base for comparison.

Fifty parts of titanium oxide surface treated by alumina and silica in a ratio of 3/1 and having an average particle diameter of 270 nm, 2.5 parts of Disperbyk-111 (made by BYK-Chemie Co., Ltd.), 42.7 parts of an ethylene oxide adduct of 1,6-hexandiol diacrylate, and 4.8 parts of 3-methoxybutyl acrylate were stirred for 1 hour by a stirrer and treated by a beads mill for 4 hours to prepare the mill base.

Next, into the mixture of polyurethhanacrylate 5.0 parts, ethyleneoxide adduct trimethylolpropanetriacrylate 10.0 parts, ethyleneoxide adduct 1,6-hexandioldiacrylate 33.0. parts, 3-methoxybuthylacrylate 12.0 parts, and DC57Additive (polyether-denaturated silicone oil, made by Dow Corning corp.) 0.1 parts; as the photo-polymerization initiator, IRUGACURE819 (made by Ciba Specialty Chemicals Co., Ltd.) 3.0 parts and Lucirin TPO (made by BASF) 3.0 parts are added and solved by warming to prepare a solution. After the mill base of 40 parts are added to the solution and sufficiently mixed, the solution is filtered with membrane filter to prepare the ink-jet ink.

<Image Formation>

The above white inks were each charged in an ink-jet recording apparatus having the constitution shown in FIG. 1 in which a piezo type ink-jet nozzle was provided, and images were formed. The ink supplying system was constituted by an ink tank, a supplying pipe, a front room arranged just before the head, a piping with a filter and the piezo head. The portion between the front room and the head was heat shielded where the ink was heated by 50° C., and the piezo head was driven so as to continuously jet out the ink in a resolution of 720×720 dpi. The ink was instantaneously, less than 0.5 seconds after the landing, hardened by the lamp units arranged on both sides of the carriage just after the landing. In the invention, the dpi is a dot number per 2.54 cm. A solid white image having a thickness after hardened of 12 μm was formed on a transparent poly(ethylene terephthalate) recording material having a transmission density of not more than 0.05 by the foregoing procedure at a condition of 25° C. and 30% HR.

<Measurement of Whiteness>

The whiteness L*,a*,b* of the above-prepared solid white image was measured by Spectrolino, manufactured by Gretag Macbeth Co., Ltd. The measurement was carried out under the following conditions; light source: D50, visual field angle: 2°, density: according to white standard of ANSI T, abs filter: No-filter, and with white backing on Tokubishi Art Paper. Results of the measurement are listed in Table 1.

<Measurement of Glossiness>

The above white ink composition was coated by a wire bar on the recording medium so that the hardened layer thickness become 12 μm and hardened by UV irradiation. The surface mirror glossiness at 60° of thus prepared hardened layer was measured according to JIS-Z-8741. An angle variable glossiness meter VGS-1001DP, manufactured by Nippondensyoku Co., Ltd., was employed for the measurement. Results of the measurement are listed in Table 1.

TABLE 1

| White ink | Whiteness | | | |
|---|---|---|---|---|
| composition | L* | a* | b* | Glossiness |
| 1 | 93.3 | −0.5 | 2.2 | 88.8 |
| 2 | 92.9 | −0.2 | 2.4 | 84.3 |
| 3 | 94.2 | 1.7 | −4.5 | 84.1 |
| 4 | 93.3 | −0.5 | 2.2 | 85.2 |
| 5 | 92.9 | −0.2 | 2.4 | 80.6 |
| 6 | 94.2 | 1.7 | −4.5 | 80.4 |
| Comparative | 91.9 | −0.7 | 3.2 | 68.4 |
| example | | | | |

It is clear from the results in Table 1 that the white images having suitable whiteness, visibility and high glossiness can be obtained by applying the invention.

The white ink composition for ink-jet printing displaying suitable whiteness, glossiness and visibility on a transparent substrate or that with low lightness, and is excellent in the color reproducibility, image quality, drying ability, adhesiveness with substrate and durability, the image forming method and the ink-jet recording apparatus employing the composition can be provided by the invention.

What is claimed is:

1. A white ink composition for ink-jet recording comprising:
a white pigment;
a dispersing agent;
a polymerizable compound; and
a photo-polymerization initiator,
wherein, when an ink-jet image is formed with the white ink composition and hardened by irradiation of an activation energy ray to have a thickness of 5 through 20 μm, the hardened ink-jet image has a whiteness with lightness index of L*>90 and a chroma indexes of −2<a*<+2 and −5<b*<+5 in CIELAB color space, and a 60° mirror surface glossiness of not less than 80.

2. The white ink composition for ink-jet recording of claim 1, wherein the white pigment is a titanium oxide.

3. The white ink composition for ink-jet recording of claim 1, wherein the dispersing agent has an acid value and an amine value.

4. The white ink composition for ink-jet recording of claim 3, wherein the acid value is greater than the amine value.

5. The white ink composition for ink-jet recording of claim 1, further comprising a silicone surfactant having HLB value of 9 through 30.

6. The white ink composition for ink-jet recording of claim 4, further comprising a silicone surfactant having HLB value of 9 through 30.

7. The white ink composition for ink-jet recording of claim 1, further comprising an oxetane compound as a dispersion medium.

8. The white ink composition for ink-jet recording of claim 4, further comprising an oxetane compound as a dispersion medium.

9. The white ink composition for ink-jet recording of claim 1, further comprising a colorant other than the white pigment.

10. The white ink composition for ink-jet recording of claim 4, further-comprising a colorant other than the white pigment.

11. The ink-jet image forming method, comprising:
ejecting the white ink composition of claim 1 onto a recording medium; and
irradiating an activation energy ray on the white ink composition ejected on the recording medium to form a hardened image.

12. The ink-jet image forming method; comprising:
ejecting the white ink composition of claim 4 onto a recording medium; and
irradiating an activation energy ray on the white ink composition ejected on the recording medium to form a hardened image.

13. The ink-jet image forming method of claim 11, wherein the step of irradiating an activation energy ray is performed at a time between 0.001 to 2.0 seconds after a landing of the white ink composition on the recording medium.

14. The ink-jet image forming method of claim 12, wherein the step of irradiating an activation energy ray is performed at a time between 0.001 to 2.0 seconds after a landing of the white ink composition on the recording medium.

15. The ink-jet image forming apparatus comprising:
a recording head to eject the white ink composition described in claim 1 onto a recording medium; and
a irradiation section to irradiate an activation energy ray on the white ink composition ejected on the recording medium to harden the white ink composition,
wherein, the recording head ejects the white ink composition after the white ink composition and the recording head have been heated to 35 through 100° C.

16. The ink-jet image forming apparatus comprising:
a recording head to eject the white ink composition described in claim 4 onto a recording medium; and
a irradiation section to irradiate an activation energy ray on the white ink composition ejected on the recording medium to harden the white ink composition,
wherein, the recording head ejects the white ink compositions after the white ink composition and the recording head have been heated to 35 through 100° C.
